(19) United States
(12) Patent Application Publication
(10) Pub. No.: US 2012/0300516 A1
(43) Pub. Date: Nov. 29, 2012

(54) POWER SUPPLY MODULE

(75) Inventors: Hung-Yi Chen, Taipei City (TW); Yi-Hsun Lin, Taipei City (TW); Yen-Chih Chen, Taipei City (TW); Wei-Chih Shih, Taipei City (TW); Ming-Hsien Lee, Taipei City (TW)

(73) Assignee: COMPAL ELECTRONICS, INC., Taipei City (TW)

(21) Appl. No.: 13/479,282

(22) Filed: May 24, 2012

Related U.S. Application Data
(60) Provisional application No. 61/489,666, filed on May 24, 2011.

(51) Int. Cl. H02M 1/00

(52) U.S. Cl. 363/78

(57) ABSTRACT

A power supply module including a cable and a power conversion device is provided. The cable includes a power line and a detection line and a terminal thereof connected to an electronic device, wherein the detection line transmits a first electrical numerical energy value of first electrical energy received by the electronic device through the power line. The power conversion device connects another terminal of the cable, transmits second electrical energy to the electronic device and includes an electrical energy control unit and a feedback unit. The feedback unit is used for receiving the first electrical numerical energy value and produces a feedback signal according to the first electrical numerical energy value. The electrical energy control unit receives an input electrical energy, connects the feedback unit, and regulates output electrical energy thereof and the second electrical energy having a second electrical numerical energy value with reference of the feedback signal.

### CROSS-REFERENCE TO RELATED APPLICATION

This application claims the priority benefits of U.S. provisional application Ser. No. 61/489,666, filed on May 24, 2011. The entirety of the above-mentioned patent applications is hereby incorporated by reference herein and made a part of this specification.

### BACKGROUND

1. Technical Field

The invention relates to a power supply module. Particularly, the invention relates to a power supply module capable of compensating a line loss.

2. Related Art

Generally, a portable electronic device can be connected to a power supply module to receive an external voltage as supplied power, i.e. the portable electronic device takes the external voltage as a power voltage, or a battery therein supplies the power voltage. In order to maintain the external voltage stable, the power supply module generally detects the output external voltage thereof, and adjusts a magnitude of the external voltage according to a detection result.

The power supply module is generally connected to the portable electronic device through a cable, and a signal line impedance of the cable increases as a length of the cable increases, so that a voltage drop is generated between the voltage supplied by the power supply module and the voltage received by the portable electronic device, which influences the external voltage received by the electronic device, namely, the cable may cause a line loss. Moreover, the greater a current flowing through the cable is, the greater the line loss caused by the cable is; and the smaller the current flowing through the cable is, the smaller the line loss caused by the cable is. Since the line loss caused by the cable is not a fixed numerical value, when the power supply module is designed, the magnitude of the external voltage received by the electronic device cannot be controlled. In case that the external voltage is varied, the electronic device probably cannot normally operate due to the influence of the external voltage.

### SUMMARY

The invention is directed to a power supply module, which is capable of compensating a line loss of a cable, so as to maintain stableness of a power voltage received by an electronic device.

The invention provides a power supply module including a cable and a power conversion device. The cable includes a power line and a detection line, and one terminal thereof is connected to an electronic device, where the detection line is configured to transmit a first electrical numerical energy value of first electrical energy received by the electronic device through the power line. The power conversion device is connected to another terminal of the cable, transmits second electrical energy to the electronic device, and includes a feedback unit and an electrical energy control unit. The feedback unit is used for receiving the first electrical numerical energy value and produces a feedback signal according to the first electrical numerical energy value. The electrical energy control unit receives an input electrical energy, and is connected to the feedback unit, and regulates output electrical energy of the electrical energy control unit and regulates the second electrical energy transmitted to the electronic device by the power conversion device with reference of the feedback signal, where the second electrical energy has a second electrical numerical energy value.

In an embodiment of the invention, the second electrical numerical energy value is influenced by a line loss of the power line, and the first electrical numerical energy value is smaller than the second electrical numerical energy value.

In an embodiment of the invention, the first electrical numerical energy value and the second electrical numerical energy value are numerical voltage values or numerical current values.

In an embodiment of the invention, the electrical energy control unit is a voltage control unit and the output electrical energy is an output voltage.

In an embodiment of the invention, the power conversion device further includes a converter and a rectifier unit. The converter has an input terminal and an output terminal, and is connected to the voltage control unit, where the voltage control unit receives an input voltage and converts the input voltage into an output voltage for providing to the input terminal, and regulates the output voltage with reference of the feedback signal, where the output voltage is an input terminal voltage of the input terminal. The rectifier unit is connected to the output terminal, and generates the second electrical energy output to the electronic device according to an output terminal voltage of the output terminal, where the second electrical energy is supplied to the electronic device through the power line to serve as a power source of the electronic device.

In an embodiment of the invention, the converter is a transformer, the input terminal is a primary winding of the transformer, the output terminal is a secondary winding of the transformer, the input terminal voltage is a primary winding voltage, the output terminal voltage is a secondary winding voltage, and the detection line transmits the first electrical numerical energy value received by the electronic device to the feedback unit, where the first electrical energy is a first voltage and the second electrical energy is a second voltage.

In an embodiment of the invention, the rectifier unit includes a first diode and a first capacitor. An anode of the first diode is connected to a first terminal of the secondary winding, and a cathode of the first diode outputs the second voltage. The first capacitor is connected between the cathode of the first diode and a second terminal of the secondary winding, where the second terminal of the secondary winding is connected to a ground voltage.

In an embodiment of the invention, the electronic device includes a first connection port, and the first connection port includes a first power pin and a first ground pin, where the power line is connected to the first power pin and the first ground pin, and the detection line is also connected to the first power pin and the first ground pin.

In an embodiment of the invention, the cable has a first connection portion corresponding to the first connection port, and the first connection portion has a first fool-proof hole, where a first signal pad of the detection line is disposed in the first fool-proof hole, so that the detection line is connected to the electronic device through the first signal pad.

In an embodiment of the invention, the feedback unit includes a first resistor, a second resistor, a third resistor, a fourth resistor, a fifth resistor, an optical coupler and a voltage regulator device. The first resistor is connected between the rectifier unit and the first power pin. A first terminal of the second resistor is connected to the first power pin through the cable, and a second terminal of the second resistor outputs a reference voltage. A first terminal of the third resistor is connected to the second terminal of the second resistor, and a second terminal of the third resistor is connected to the first ground pin through the cable. The fourth resistor is connected between the second terminal of the third resistor and a ground voltage. A first terminal of the fifth resistor is connected to the rectifier unit. The optical coupler has an input side and an output side. A first terminal of the input side is connected to a second terminal of the fifth resistor, a first terminal of the output side provides a feedback current, and a second terminal of the output side is connected to the ground voltage. The voltage regulator device has an input terminal, an output terminal and a control terminal, the input terminal of the voltage regulator device is connected to the second terminal of the third resistor, the output terminal of the voltage regulator device is connected to a second terminal of the input side of the optical coupler, and the control terminal is connected to the second terminal of the second resistor for receiving the reference voltage, where the voltage regulator device determines a conduction state between the input terminal and the output terminal thereof according to the reference voltage.

In an embodiment of the invention, the voltage regulator device includes a TL431 triode, an anode of the TL431 triode is the input terminal of the voltage regulator device, a cathode of the TL431 triode is the output terminal of the voltage regulator device, and a reference voltage terminal of the TL431 triode is the control terminal of the voltage regulator device.

In an embodiment of the invention, resistances of the second resistor and the third resistor are greater than resistances of the first resistor and the fourth resistor.

In an embodiment of the invention, the first terminal of the fifth resistor is connected to the rectifier unit through the first resistor.

In an embodiment of the invention, the feedback unit further includes a sixth resistor and a second capacitor. The second capacitor and the sixth resistor are connected in series between the output terminal and the control terminal of the voltage regulator device.

In an embodiment of the invention, the cable includes a first signal line, a second signal line, a third signal line and a fourth signal line, where the first signal line and the fourth signal line are connected to the rectifier unit and the electronic device to serve as the power line, and are respectively connected to a first power pin and a first ground pin of the electronic device for transmitting the second electrical energy to the electronic device, and the second signal line and the third signal line are connected to the feedback unit and the electronic device to serve as the detection line for transmitting the first electrical numerical energy value to the feedback unit.

In an embodiment of the invention, the power supply module further includes a second connection port having a second power pin and a second ground pin, the first signal line is connected to the rectifier unit through the second power pin, and the fourth signal line is connected to the rectifier unit through the second ground pin.

In an embodiment of the invention, the second connection port further includes a first pin and a second pin, the second signal line is connected to the feedback unit through the first pin, and the third signal line is connected to the feedback unit through the second pin.

In an embodiment of the invention, the cable has a second connection portion corresponding to the second connection port, and the second connection portion has a second fool-proof hole, where a second signal pad of the detection line is disposed in the second fool-proof hole, so that the detection line is connected to the power supply module through the second signal pad.

According to the above descriptions, in the power supply module of the invention, the feedback unit receives the first electrical numerical energy value of the first electrical energy received by the electronic device through the cable, and generates the feedback signal according to the first electrical numerical energy value, so as to control the electrical energy control unit to regulate the output voltage thereof and regulate the second electrical energy transmitted to the electronic device by the power conversion device. In this way, the line loss of the cable is compensated.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system schematic diagram of a power supply module according to an embodiment of the invention.

FIG. 2 is a circuit schematic diagram of a power supply module according to an embodiment of the invention.

FIG. 3 is a circuit schematic diagram of a power supply module according to an embodiment of the invention.

FIG. 4 is a circuit schematic diagram of a power supply module according to an embodiment of the invention.

FIG. 5 is a circuit schematic diagram of a power supply module according to an embodiment of the invention.

FIG. 6 is a circuit schematic diagram of a power supply module according to an embodiment of the invention.

FIG. 7 is a structural schematic diagram of a cable of FIG. 1 according to an embodiment of the invention.

### DETAILED DESCRIPTION OF DISCLOSED EMBODIMENTS

FIG. 1 is a system schematic diagram of a power supply module connected to an electronic device according to an embodiment of the invention. Referring to FIG. 1, in the present embodiment, the electronic device 10 includes the first connection port 11, where the first connection port 11 can be a power supply terminal, an universal serial bus (USB) connection port or a similar structure, which is not limited by the invention. Moreover, the first connection port 11 generally has the first power pin 11P and the first ground pin 11G. The power supply module 100 includes a cable 110 and a power conversion device 120, where one terminal of the cable 110 is connected to the first connection port 11 of the electronic device 10, and another terminal of the cable 110 is connected to the power conversion device 120.

Here, the power conversion device 120 receives the first electrical numerical energy value of the first electrical energy (for example, a power voltage Vp) received by the electronic device 10 through the cable 110, and transmits second electrical energy (for example, an output voltage Vo) to the electronic device 10 through the cable 110. Moreover, the second electrical numerical energy value of the second electrical energy is influenced by a line loss of the cable 110, so that the first electrical numerical energy value is smaller than the second electrical numerical energy value, where the first electrical numerical energy value and the second electrical numerical energy value can be a numerical voltage value or a numerical current value, which is determined by an actual circuit design, and is not limited by the invention.

The power conversion device 120 includes an electrical energy control unit, a converter, a rectifier unit 126 and a feedback unit 127, where the electrical energy control unit can be a voltage control unit 121, and the converter can be a transformer 123. The converter includes an input terminal and an output terminal, where the input terminal of the converter is a primary winding 123a of the transformer 123, and the output terminal of the converter is the secondary winding 123b of the transformer 123.

In an embodiment, the voltage control unit 121 receives an input voltage Vin (corresponding to input electrical energy) and is connected to the primary winding 123a of the transformer 123, where the input voltage Vin can be a direct current (DC) voltage or an alternating current (AC) voltage, which is determined according to an actual circuit design. The voltage control unit 121 converts the input voltage Vin into a primary winding voltage Va (corresponding the output electrical energy and an input terminal voltage) for providing to the primary winding 123a of the transformer 123, and regulates an average voltage of the primary winding voltage Va according to a feedback signal (which is, for example, a feedback current If). The primary winding 123a of the transformer 123 receives the primary winding voltage Va, and produces the secondary winding voltage Vb (corresponding to an output terminal voltage) at the secondary winding 123b thereof.

The rectifier unit 125 is connected to the secondary winding 123b of the transformer 123, and produces an output voltage Vo according to the secondary winding voltage Vb output from the secondary winding 123b. The output voltage Vo is supplied to the first power pin 11P and the first ground pin 11G of the first connection port 11 of the electronic device 10 through the cable 110 to serve as the power voltage Vp of the electronic device 10. The feedback unit 127 is connected to the rectifier unit 125, and is connected to the first power pin 11P and the first ground pin 11G through the cable line 110, and produces a feedback signal according to a magnitude of the power voltage Vp received by the electronic device 10, where the feedback signal can be the feedback current If. In this way, since the feedback unit 127 produces the feedback current If according to the power voltage Vp received by the electronic device 10, the feedback unit 127 can adjust the feedback current If according to the line loss of the cable 110, so as to regulate the average voltage of the primary winding voltage Va through the voltage control unit 121, and accordingly regulate the output voltage Vo output by the rectifier unit 125. In this way, the line loss of the cable 110 is compensated.

In the present embodiment, the cable 110 includes the first signal line SL1, the second signal line SL2, the third signal line SL3 and the fourth signal line SL4. The first signal line SL1 is connected to the rectifier unit 125 and the first power pin 11P, the second signal line SL2 is connected to the feedback unit 127 and the first power pin 11P, the third signal line SL3 is connected to the feedback unit 127 and the first ground pin 11G, and the fourth signal line SL4 is connected to the rectifier unit 125 and the first ground pin 11G. The first signal line SL1 and the fourth signal line SL4 can be regarded as a power line used for transmitting power, which transmits the output voltage Vo to the first power pin 11P and the first ground pin 11G of the electronic device 10 to serve as the power of the electronic device 10, and the second signal line SL2 and the third signal L3 can be regarded as a detection line used for detecting the power voltage VP, which transmits the power voltage VP received by the electronic device 10 to the feedback unit 127.

In view of circuit operation, when the electronic device 10 operates, the electronic device 10 receives a required voltage and a required current through the first signal line SL1 and the fourth signal line SL4, where the required current of the electronic device 10 is varied according to a working state thereof. Moreover, the current transmitted to the electronic device 10 through the first signal line SL1 and the fourth signal line SL4 may have a voltage drop due to line impedances of the first signal line SL1 and the second signal line SL4, which results in a fact that the power voltage Vp is smaller than the output voltage Vo. On the other hand, the feedback unit 127 detects a magnitude of the power voltage Vp (i.e. detects a numerical voltage value of the power voltage Vp) through the second signal line SL2 and the third signal line SL3, and since a current required for detecting the voltage is relatively low, the voltage drop generated by the second signal line SL2 and the third signal line SL3 is relatively low, so that the feedback unit 127 can correctly detect the magnitude of the power voltage Vp. Accordingly, the voltage control unit 121 can correctly regulate the average voltage of the primary winding voltage Va to compensate the line loss caused by the first signal lien SL1 and the fourth signal line SL4 of the cable 110.

In the present embodiment, the transformer 123 and the rectifier unit 125 can be selectively used. Therefore, in another embodiment of the invention, the transformer and the rectifier unit (for example, 125) can be omitted, i.e. the power conversion unit (for example, 120) includes the electrical energy control unit (for example, the voltage control unit 121) and the feedback unit 127.

According to the above descriptions, a cable (for example, 110) provided by a power supply module (for example, 100) of the present embodiment can be used to connect an electronic device (for example, 10) and a power conversion device (for example, 120), where the cable (for example, 110) includes a power line (for example, the signal lines SL1 and SL4) and a detection line (for example, the signal lines SL2 and SL3). The detection line (for example, the signal lines SL2 and SL3) is mainly used to transmit the first electrical numerical energy value of the first electrical energy (for example, the power voltage Vp) received by the electronic device (for example, 10) through the power line (for example, the signal lines SL1 and SL4), where the first electrical numerical energy value is a numerical current value or a numerical voltage value. In the present embodiment, the electrical numerical energy value transmitted to the feedback unit (for example, 127) by the detection line (for example, the signal lines SL2 and SL3) is a numerical voltage value, though the invention is not limited thereto. The power conversion device (for example, 120) transmits second electrical energy (for example, the output voltage Vo) to the electronic device (for example, 10) through the power line (for example, the signal lines SL1 and SL4), where the second electrical energy has a second electrical numerical energy value. The power conversion device (for example, 120) is mainly composed of the feedback unit (for example, 127) and an electrical energy control unit, where the electrical energy control unit can be a voltage control unit (for example, 121). The feedback unit (for example, 127) receives the first electrical numerical energy value and produces a feedback signal (for example, the feedback current If) according to the first electrical numerical energy value. The electrical energy control unit (for example, the voltage control unit 121) receives input electrical energy (for example, the input voltage Vin) and is connected to the feedback unit (for example, 127), and regulates output electrical energy (for example, the primary winding voltage Va) of the electrical energy control unit (for example, the voltage control unit 121) and regulates the second electrical energy (for example, the output voltage Vo) transmitted to the electronic device by the power conversion device (for example, 120) with reference of the feedback signal (for example, the feedback current If). Since the second electrical energy (for example, the output voltage Vo) transmitted by the power conversion device (for example, 120) is influenced by the line loss of the power line (for example, the signal lines SL1 and SL4), the first electrical numerical energy value received by the electronic device (for example, 10) through the power line (for example, the signal lines SL1 and SL4) is generally smaller than the second electrical numerical energy value. In the invention, the second electrical energy (for example, the output voltage Vo) output by the power conversion device (for example, 120) is regulated to compensate the energy loss caused by the power line (for example, the signal lines SL1 and SL4).

The power conversion device (for example, 120) further includes a converter (for example, the transformer 123) and a rectifier unit (for example, 125), where the converter (for example, the transformer 123) is connected to the electrical energy control unit (for example, the voltage control unit 121), and the rectifier unit (for example, 125) is connected to the converter (for example, the transformer 123). When the electrical energy control unit is the voltage control unit (for example, 121) and the output electrical energy of the electrical energy control unit is the output voltage (for example, the primary winding voltage Va), the voltage control unit (for example, 121) converts a received input voltage (for example, Vin) into the output voltage (for example, the primary winding voltage Va) for supplying to the input terminal (for example, the primary winding 123a of the transformer 123) of the converter, and meanwhile the voltage control unit (for example, 121) regulates the output voltage (for example, the primary winding voltage Va) with reference of the feedback signal (for example, the feedback current If), where the output voltage is the input terminal voltage of the input terminal of the converter (for example, the primary winding voltage Va). The rectifier unit (for example, 125) is connected to the output terminal of the converter (for example, the secondary winding 123b of the transformer 123), and produces the second electrical energy (for example, the output voltage Vo) for outputting to the electronic device (for example, 10) according to an output terminal voltage (for example, the secondary winding voltage Vb) of the output terminal (for example, the secondary winding 123b), where the second electrical energy (for example, the output voltage Vo) is supplied to the electronic device (for example, 10) to serve as a power of the electronic device through the power line (for example, the signal lines SL1 and SL4).

In the present embodiment, the converter is a transformer (for example, 123), the input terminal of the converter is the primary winding (for example, 123a) of the transformer, the output terminal of the converter is the second winding (for example, 123b) of the transformer, the input terminal electrical energy of the converter is the primary winding voltage (for example, Va), the output terminal electrical energy of the converter is the secondary winding voltage (for example, Vb), and the detection line (for example, the signal lines SL2 and SL3) transmits the first electrical numerical energy value received by the electronic device (for example, 10) to the feedback unit (for example, 127).

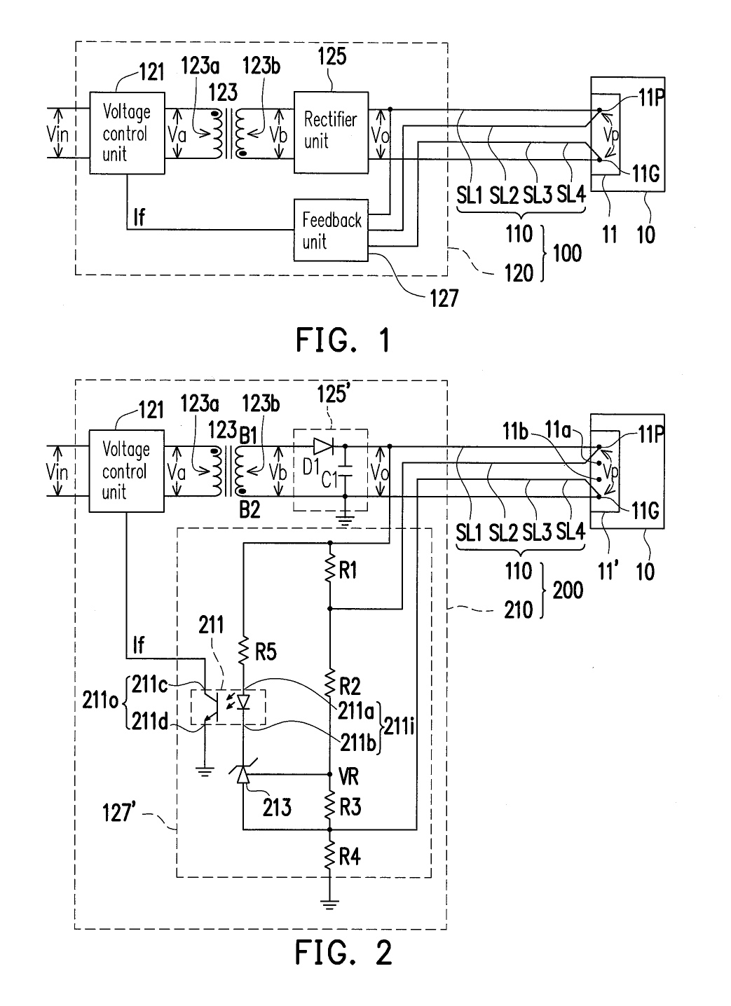

FIG. 2 is a circuit schematic diagram of a power supply module connected to an electronic device according to an embodiment of the invention. Referring to FIG. 1 and FIG. 2, the power supply module 200 is a further implementation of the power supply module 100, and like reference numerals refer to the like elements throughout. In the present embodiment, the cable 110 of the invention is, for example, fixed to a power conversion device 210. According to a different product design, the cable 110 can also be detachably connected to the power conversion device 210, which is not limited by the invention. The first connection port 11′ of the electronic device 10 is, for example, a USB connection port, i.e. the first connection port 11′ has the first power pin 11P, the first ground pin 11G and data pins 11a and 11b (corresponding to a third pin and a fourth pin).

The rectifier unit 125′ includes the first diode D1 and the first capacitor C1. An anode of the first diode D1 is connected to a first terminal B1 of the secondary winding 123b of the transformer 123, and a cathode of the first diode D1 outputs the output voltage Vo. The first capacitor C1 is connected between the cathode of the first diode D1 and the second terminal B2 of the secondary winding 123b of the transformer 123, where the second terminal B2 of the secondary winding 123b of the transformer 123 is connected to a ground voltage.

In the present embodiment, the feedback unit 127′ includes the first resistor R1, the second resistor R2, the third resistor R3, the fourth resistor R4, the fifth resistor R5, an optical coupler 211 and a voltage regulator device, where the voltage regulator device is, for example, implemented by a TL431 triode 213. The first resistor R1 is connected between the rectifier unit 125′ and the first power pin 11P. A first terminal of the second resistor R2 is connected to the first power pin 11P through the second signal line SL2 of the cable 110, and a second terminal of the second resistor R2 outputs a reference voltage VR. A first terminal of the third resistor R3 is connected to the second terminal of the second resistor R2, and a second terminal of the third resistor R3 is connected to the first ground pin 11G through the third signal line SL3 of the cable 110. The fourth resistor R4 is connected between the second terminal of the third resistor R3 and the ground voltage, and spaces the rectifier unit 125′ and the first ground pin 11G.

The first terminal of the fifth resistor R5 is connected to the rectifier unit 125′ for receiving the output voltage Vo. The optical coupler 211 has an input side 211i and an output side 211o. The first terminal 211a of the input side 211i is connected to the second terminal of the fifth resistor R5, the first terminal 211c of the output side 211o provides the feedback current If, and the second terminal 211d of the output side 211o is connected to the ground voltage.

An anode of the TL431 triode 213 (corresponding to an input terminal of the voltage regulator device) is connected to the second terminal of the third resistor R3, a cathode of the TL431 triode 213 (corresponding to an output terminal of the voltage regulator device) is connected to the second terminal 211b of the input side 211i of the optical coupler 211, and a reference voltage terminal of the TL431 triode 213 (corresponding to a control terminal of the voltage regulator device) is connected to the second terminal of the second resistor R2 for receiving the reference voltage VR. Generally, the TL431 triode 213 determines a conduction state between the anode and the cathode thereof according to a voltage (the reference voltage VR in the present embodiment) received by the reference voltage terminal thereof, i.e. the TL431 triode 213 determines a magnitude of a current flowing through the anode and the cathode thereof according to the voltage (the reference voltage VR in the present embodiment) received by the reference voltage terminal thereof. In other words, the voltage regulator device determines a conduction state between the input terminal and the output terminal thereof according to the reference voltage VR.

In the present embodiment, the first resistor R1 and the fourth resistor R4 can space the rectifier unit 125′ and the first power pin 11P and the first ground pin 11G, and prevent a current of the rectifier unit 125′ from flowing to the ground voltage through the feedback unit 127′ to influence the feedback current If generated by the feedback unit 127′. Since a voltage difference between the rectifier unit 125′ and the first power pin 11P and the first ground pin 11G is relatively low, the first resistor R1 and the fourth resistor R4 may have a relatively low resistance. Due to a voltage difference between the first power pin 11P and the first ground pin 11G, and the feedback unit 127′ is prevented from draining excessive current to perform the voltage detection to influence the operation of the electronic device 10, the second resistor R2 and the third resistor R3 may have a relatively high resistance. According to the above descriptions, the resistance of the second resistor R2 and the third resistor R3 can be greater than the resistance of the first resistor R1 and the fourth resistor R4.

In the present embodiment, the current received by the input side 211i of the optical coupler 211 is controlled by the conduction state of the anode and the cathode of the TL431 triode 213, and the conduction state of the anode and the cathode of the TL431 triode 213 are controlled by the reference voltage VR. The reference voltage VR is generated through the second resistor R2 and the third resistor R3 by dividing the power voltage Vp. Therefore, the feedback current If provided by the output side 211o of the optical coupler 211 is varied along with the power voltage Vp, and the voltage control unit 121 regulates the average voltage of the primary winding voltage Va according to the feedback current If to compensate the line loss caused by the first signal line SL1 and the fourth signal line SL4 of the cable 110.

In the connection port complied with a USB 2.0 specification, the data pins 11a and 11b of the electronic device 10 can be respectively a positive data pin and a negative data pin.

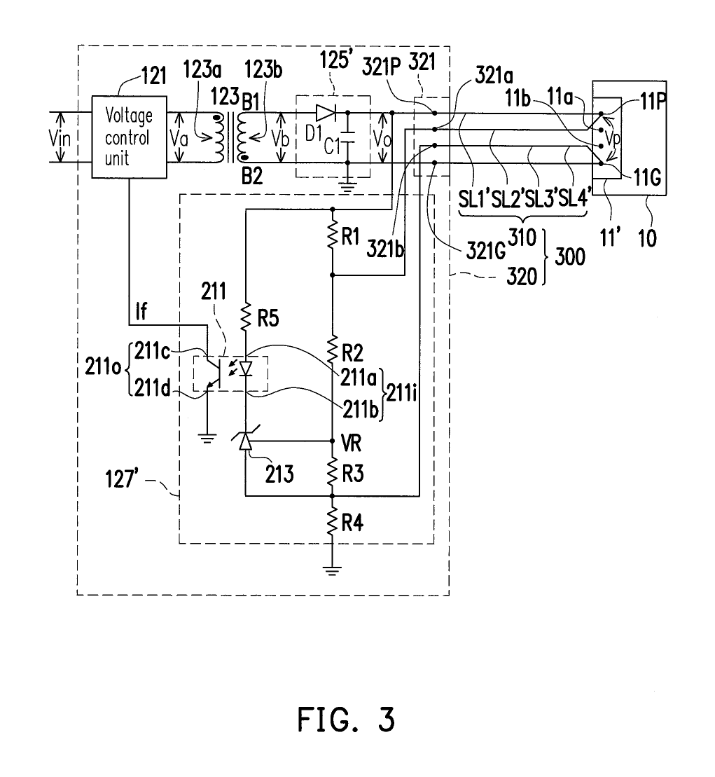

FIG. 3 is a circuit schematic diagram of a power supply module connected to an electronic device according to an embodiment of the invention. Referring to FIG. 1 to FIG. 3, the power supply module 300 is a further implementation of the power supply module 100, and a structure of the power supply module 300 is similar to that of the power supply module 200, where like reference numerals refer to the like elements throughout. In the present embodiment, the cable 310 of the invention is, for example, movably connected to a power conversion device 320, i.e. the power conversion device 320 includes a second connection port 321. The first connection port 11′ of the electronic device 10 and the second connection port 321 of the power conversion device 320 are, for example, USB connection ports, i.e. the first connection port 11′ has the first power pin 11P, the first ground pin 11G and the data pins 11a and 11b (corresponding to the third pin and the fourth pin), and the second connection port 321 has the second power pin 321P, the second ground pin 321G and pins 321a and 321b (corresponding to the first pin and the second pin), where the pins 321a and 321b can be data pins or extra pins, which is not limited by the invention.

In the present embodiment, the first signal line SL1′ is connected to the cathode of the first diode D1 of the rectifier unit 125′ through the second power pin 321P, the second signal line SL2′ is connected to the first terminal of the second resistor R1 of the feedback unit 127′ through the pin 321a, the third signal line SL3′ is connected to the second terminal of the third resistor R3 of the feedback unit 127′ through the pin 321b, and the fourth signal line SL4′ is connected to the first capacitor C1 of the rectifier unit 125′ through the second ground pin 321G.

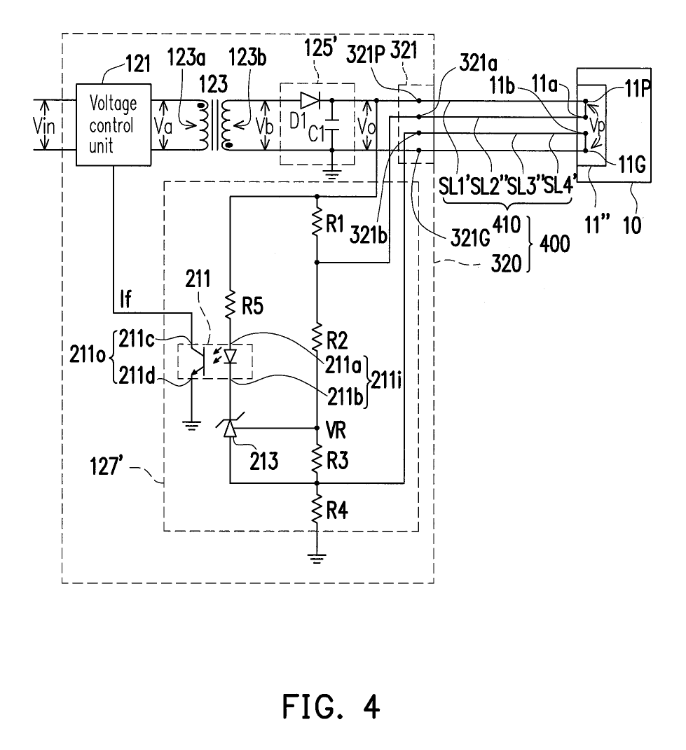

FIG. 4 is a circuit schematic diagram of a power supply module connected to an electronic device according to an embodiment of the invention. Referring to FIG. 1, FIG. 3 and FIG. 4, the power supply module 400 is a further implementation of the power supply module 100, and a structure of the power supply module 400 is similar to that of the power supply module 300, where like reference numerals refer to the like elements throughout. In the present embodiment, the cable 410 of the present embodiment is also movably connected to the power conversion device 320.

Generally, some electronic devices do not have the demand in data transmission, so that the connection port (for example, the USB connection port) on the electronic device is only used for power transmission. Now, the data pins 11a and 11b of the first connection port 11″ of the electronic device 10 can be used for voltage feedback, i.e. the data pin 11a can be connected to the first power pin 11P, and the data pin 11b can be connected to the first ground pin 11G. Therefore, the second signal line SL2″ can be connected to the first power pin 11P through the data pin 11a of the first connection port 11″, and the third signal line SL3″ can be connected to the first ground pin 11G through the data pin 11b of the first connection port 11″.

In the connection port complied with the USB 2.0 specification, the data pin 11a of the electronic device 10 and the pin 321a of the power conversion device 320 can be respectively one of a positive data pin and a negative data pin, and the data pin 11b of the electronic device 10 and the pin 321b of the power conversion device 320 can be respectively another one of the positive data pin and the negative data pin. In the connection port complied with a USB 3.0 specification, the data pin 11a of the electronic device 10 and the pin 321a of the power conversion device 320 can be respectively one of a positive signal receiving pin and a positive signal transmitting pin, and the data pin 11b of the electronic device 10 and the pin 321b of the power conversion device 320 can be respectively one of a negative signal receiving pin, a negative signal transmitting pin and a signal ground pin.

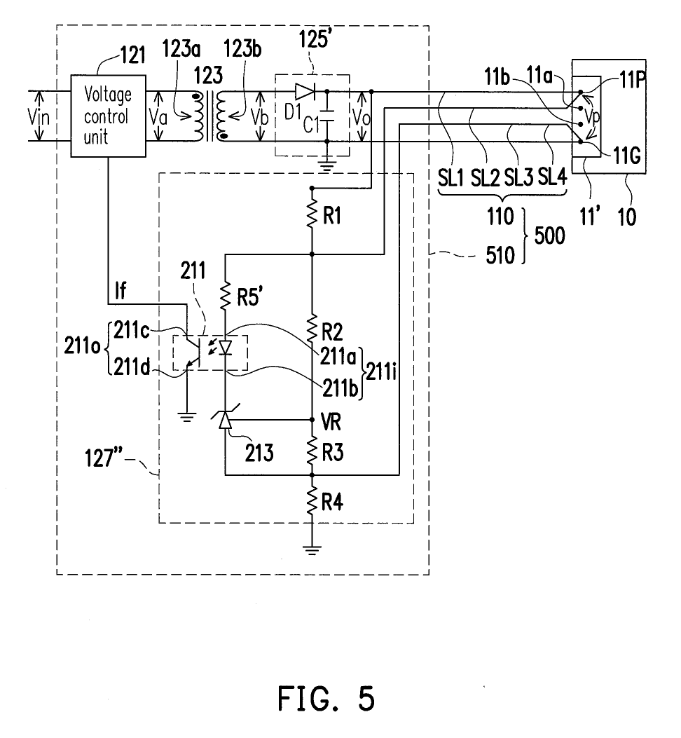

FIG. 5 is a circuit schematic diagram of a power supply module connected to an electronic device according to an embodiment of the invention. Referring to FIG. 1, FIG. 2 and FIG. 5, the power supply module 500 is a further implementation of the power supply module 100, and a structure of the power supply module 500 is similar to that of the power supply module 200, and a difference there between lies in the feedback unit 127″ of the power conversion circuit 510, where like reference numerals refer to the like elements throughout. In the present embodiment, the first terminal of the fifth resistor R5′ of the feedback unit 127″ is connected to the rectifier unit 125′ through the first resistor R1.

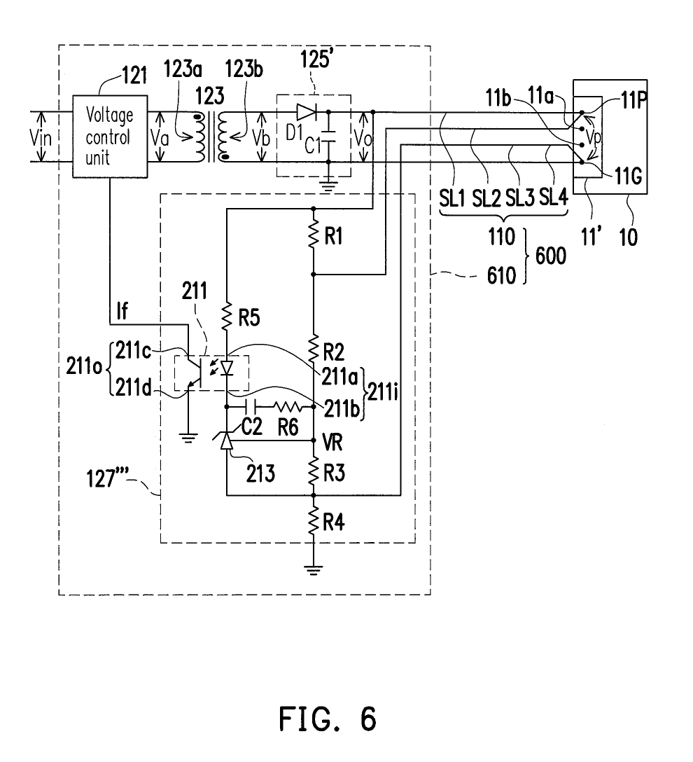

FIG. 6 is a circuit schematic diagram of a power supply module connected to an electronic device according to an embodiment of the invention. Referring to FIG. 1, FIG. 2 and FIG. 6, the power supply module 600 is a further implementation of the power supply module 100, and a structure of the power supply module 600 is similar to that of the power supply module 200, and a difference there between lies in the feedback unit 127′″ of the power conversion circuit 610, where like reference numerals refer to the like elements throughout. In the present embodiment, the feedback unit 127′″ further includes the sixth resistor R6 and the second capacitor C2. The sixth resistor R6 and the second capacitor C2 are connected in series between the reference voltage terminal and the cathode of the TL431 triode 213 (i.e. connected in series between the output terminal and the control terminal of the voltage regulator device) for filtering noises of the power conversion device 610, so as to improve stability of the power conversion device 610 and improve stability of the reference voltage VR.

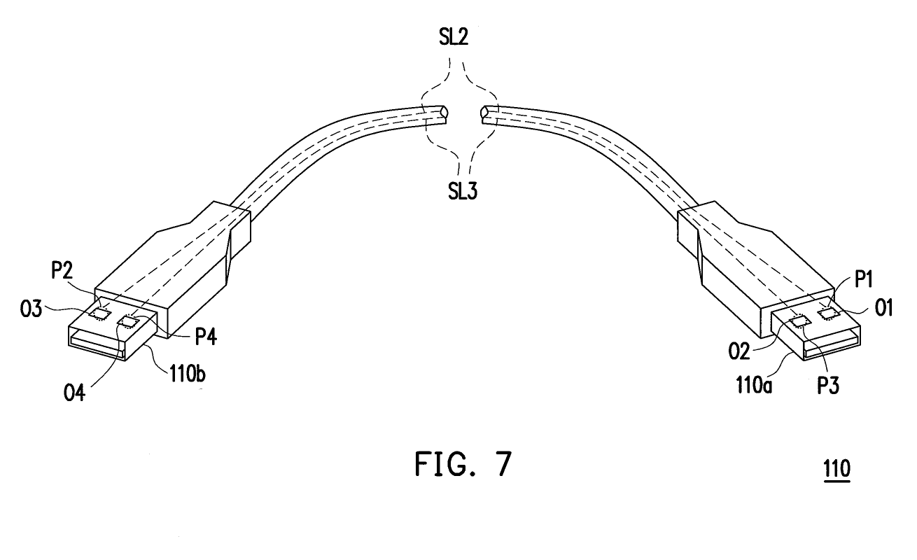

FIG. 7 is a structural schematic diagram of the cable of FIG. 1 according to an embodiment of the invention. Referring to FIG. 3 and FIG. 7, in the present embodiment, taking the power conversion device 320 as an example, the cable 110 of the invention is, for example, movably connected to the power conversion device 320, and the required components are schematically illustrated to simplify the figure. The first connection port 11′ of electronic device 10 and the second connection port 321 of the power conversion circuit 320 are respectively USB connection ports, i.e. the cable 110 is a USB cable.

In the present embodiment, the cable 110 has a first connection portion 110a and a second connection portion 110b, where the first connection portion 110a, for example, corresponds to the first connection port 11′ and has first fool-proof holes O1 and O2, and the second connection portion 110b, for example, corresponds to the second connection port 321 and has second fool-proof holes O3 and O4. A first signal pad P1 of the second signal line SL2 is disposed in the first fool-proof hole O1 of the first connection portion 110a, a second signal pad P2 of the second signal line SL2 is disposed in the second fool-proof hole O3 of the second connection portion 110b, a first signal pad P3 of the third signal line SL3 is disposed in the first fool-proof hole O2 of the first connection portion 110a, and a second signal pad P4 of the third signal line SL3 is disposed in the second fool-proof hole O4 of the second connection portion 110b.

In this way, two pins (corresponding to the third pin and the fourth pin, not shown) respectively connected to the first power pin 11P and the first ground pin 11G can be disposed in the first connection port 11′ corresponding to the first fool-proof holes O1 and O2, so that when the first connection portion 110a is plugged into the first connection port 11′, the above pins (not shown) are respectively connected to the first signal pads P1 and P3, and the second signal line SL2 and the third signal line SL3 are connected to the electronic device 10. Moreover, two other pins (corresponding to the first pin and the second pin, not shown) respectively connected to the feedback unit 127′ can be disposed in the second connection port 321 corresponding to the second fool-proof holes O3 and O4, so that when the second connection portion 110b is plugged into the second connection port 321, the above pins (not shown) are respectively connected to the second signal pads P2 and P4, and the second signal line SL2 and the third signal line SL3 are connected to the power conversion device 320. In this way, in case that the cable 110 is shared, the data pins (for example, 11a, 11b, 321a and 321b) of the connection ports (for example, 11 and 321) are not occupied.

In summary, in the power supply module of the invention, the feedback unit receives the first electrical numerical energy value of the first electrical energy received by the electronic device through the cable, and generates the feedback signal (for example, the feedback current) according to the first electrical numerical energy value, so as to control the electrical energy control unit to regulate the output voltage thereof and regulate the second electrical energy transmitted to the electronic device by the power conversion device. In this way, the line loss of the cable is compensated. Moreover, a resistor and a capacitor can be connected in series between the output terminal and the control terminal of the voltage regulator device, so as to improve stability of the power conversion device and improve stability of the reference voltage.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power supply module, comprising:
a cable, comprising a power line and a detection line, and having one terminal connected to an electronic device, wherein the detection line is configured to transmit a first electrical numerical energy value of first electrical energy received by the electronic device through the power line;
a power conversion device, connected to another terminal of the cable and transmitting a second electrical energy to the electronic device, wherein the power conversion device comprising:
a feedback unit, receiving the first electrical numerical energy value and producing a feedback signal according to the first electrical numerical energy value; and
an electrical energy control unit, receiving an input electrical energy, and connected to the feedback unit, wherein the electrical energy control unit regulates an output electrical energy of the electrical energy control unit and regulates the second electrical energy transmitted to the electronic device by the power conversion device with reference of the feedback signal, and the second electrical energy has a second electrical numerical energy value.

2. The power supply module as claimed in claim 1, wherein the second electrical numerical energy value is influenced by a line loss of the power line, and the first electrical numerical energy value is smaller than the second electrical numerical energy value.

3. The power supply module as claimed in claim 1, wherein the first electrical numerical energy value and the second electrical numerical energy value are numerical voltage values or numerical current values.

4. The power supply module as claimed in claim 1, wherein the electrical energy control unit is a voltage control unit and the output electrical energy is an output voltage.

5. The power supply module as claimed in claim 4, wherein the power conversion device further comprises:
a converter, having an input terminal and an output terminal, and connected to the voltage control unit, wherein the voltage control unit receives an input voltage and converts the input voltage into an output voltage for providing to the input terminal, and regulates the output voltage with reference of the feedback signal, wherein the output voltage is an input terminal voltage of the input terminal; and
a rectifier unit, connected to the output terminal, and generating the second electrical energy output to the electronic device according to an output terminal voltage of the output terminal, wherein the second electrical energy is supplied to the electronic device through the power line to serve as a power source of the electronic device.

6. The power supply module as claimed in claim 5, wherein the converter is a transformer, the input terminal is a primary winding of the transformer, the output terminal is a secondary winding of the transformer, the input terminal voltage is a primary winding voltage, the output terminal voltage is a secondary winding voltage, and the detection line transmits the first electrical numerical energy value received by the electronic device to the feedback unit, wherein the first electrical energy is a first voltage and the second electrical energy is a second voltage.

7. The power supply module as claimed in claim 6, wherein the rectifier unit comprises:
a first diode, having an anode connected to a first terminal of the secondary winding, and a cathode outputting the second voltage; and
a first capacitor, connected between the cathode of the first diode and a second terminal of the secondary winding, wherein the second terminal of the secondary winding is connected to a ground voltage.

8. The power supply module as claimed in claim 6, wherein the electronic device comprises a first connection port, and the first connection port comprises a first power pin and a first ground pin, wherein the power line is connected to the first power pin and the first ground pin, and the detection line is also connected to the first power pin and the first ground pin.

9. The power supply module as claimed in claim 8, wherein the cable has a first connection portion corresponding to the first connection port, and the first connection portion has a first fool-proof hole, wherein a first signal pad of the detection line is disposed in the first fool-proof hole, so that the detection line is connected to the electronic device through the first signal pad.

10. The power supply module as claimed in claim 8, wherein the feedback unit comprises:
a first resistor, connected between the rectifier unit and the first power pin;
a second resistor, having a first terminal connected to the first power pin through the cable, and a second terminal outputting a reference voltage;
a third resistor, having a first terminal connected to the second terminal of the second resistor, and a second terminal connected to the first ground pin through the cable;
a fourth resistor, connected between the second terminal of the third resistor and a ground voltage;
a fifth resistor, having a first terminal connected to the rectifier unit;
an optical coupler, having an input side and an output side, wherein a first terminal of the input side is connected to a second terminal of the fifth resistor, a first terminal of the output side provides a feedback current, and a second terminal of the output side is connected to the ground voltage; and
a voltage regulator device, having an input terminal, an output terminal and a control terminal, wherein the input terminal of the voltage regulator device is connected to the second terminal of the third resistor, the output terminal of the voltage regulator device is connected to a second terminal of the input side of the optical coupler, and the control terminal is connected to the second terminal of the second resistor for receiving the reference voltage, wherein the voltage regulator device determines a conduction state between the input terminal and the output terminal thereof according to the reference voltage.

11. The power supply module as claimed in claim 10, wherein the voltage regulator device comprises a TL431 triode, an anode of the TL431 triode is the input terminal of the voltage regulator device, a cathode of the TL431 triode is the output terminal of the voltage regulator device, and a reference voltage terminal of the TL431 triode is the control terminal of the voltage regulator device.

12. The power supply module as claimed in claim 10, wherein resistances of the second resistor and the third resistor are greater than resistances of the first resistor and the fourth resistor.

13. The power supply module as claimed in claim 10, wherein the first terminal of the fifth resistor is connected to the rectifier unit through the first resistor.

14. The power supply module as claimed in claim 10, wherein the feedback unit further comprises:
a sixth resistor; and
a second capacitor, wherein the second capacitor and the sixth resistor are connected in series between the output terminal and the control terminal of the voltage regulator device.

15. The power supply module as claimed in claim 5, wherein the cable comprises a first signal line, a second signal line, a third signal line and a fourth signal line, wherein the first signal line and the fourth signal line are connected to the rectifier unit and the electronic device to serve as the power line, and are respectively connected to a first power pin and a first ground pin of the electronic device for transmitting the second electrical energy to the electronic device, and the second signal line and the third signal line are connected to the feedback unit and the electronic device to serve as the detection line for transmitting the first electrical numerical energy value to the feedback unit.

16. The power supply module as claimed in claim 15, further comprising a second connection port having a second power pin and a second ground pin, wherein the first signal line is connected to the rectifier unit through the second power pin, and the fourth signal line is connected to the rectifier unit through the second ground pin.

17. The power supply module as claimed in claim 16, wherein the second connection port further comprises a first pin and a second pin, the second signal line is connected to the feedback unit through the first pin, and the third signal line is connected to the feedback unit through the second pin.

18. The power supply module as claimed in claim 16, wherein the cable has a second connection portion corresponding to the second connection port, and the second connection portion has a second fool-proof hole, wherein a second signal pad of the detection line is disposed in the second fool-proof hole, so that the detection line is connected to the power supply module through the second signal pad.
